(19) United States
(12) Patent Application Publication
(10) Pub. No.: US 2026/0252488 A1
(43) Pub. Date: Aug. 27, 2026

(54) CACHING AND STASHING ENGINE DESIGN FOR COMPRESSED MEMORY SYSTEMS

(71) Applicant: Samsung Electronics Co., Ltd., Gyeonggi-do (KR)

(72) Inventors: Lide DUAN, San Jose, CA (US); Nhon QUACH, San Jose, CA (US); Rahul TOLEY, Austin, TX (US)

(21) Appl. No.: 19/202,254

(22) Filed: May 8, 2025

Related U.S. Application Data
(60) Provisional application No. 63/763,614, filed on Feb. 26, 2025.

(51) Int. Cl. G06F 12/0802

(52) U.S. Cl. CPC G06F 12/0802; G06F 2212/1016

(57) ABSTRACT

A method and a system for operating a compressed memory system are provided. The method includes: receiving a request for a cache line (CL); retrieving a first data tile from a memory in response to the request, the first data tile including the CL and a plurality of additional CLs; determining, based on application behavior, not to cache the CL in a system level cache (SLC); determining, based on the application behavior, to stash a second data tile in the SLC; and stashing the second data tile in the SLC in response to the determination to stash.

### CROSS-REFERENCE TO RELATED APPLICATION

This application claims the priority benefit under 35 U.S.C. § 119(e) of U.S. Provisional Application No. 63/763,614, filed on Feb. 26, 2025, the disclosure of which is incorporated by reference in its entirety as if fully set forth herein.

### TECHNICAL FIELD

The disclosure generally relates to compressed memory systems. More particularly, the subject matter disclosed herein relates to improvements to compression decompression units (CDUs) for use in compressed memory systems.

### SUMMARY

In system-on-chip (SoC) designs, data compression may be employed to alleviate memory bandwidth pressure and reduce power consumption. In SoCs featuring a compressed memory system, data is exchanged between components such as a central processing unit (CPU) and an image signal processor (ISP) using compressed data buffers stored in dynamic random access memory (DRAM), typically following a producer-consumer model. The ISP, acting as a producer, compresses, for example, camera data and stores it in DRAM, while the CPU, as the consumer, retrieves and decompresses the data for use. Both the ISP and CPU may utilize a CDU to perform data transformations. Since a system level cache (SLC) holds uncompressed data, the CDU is normally positioned between the SLC and DRAM to manage data conversions during memory transactions. This compressed memory architecture may improve efficiency but also introduces challenges in cache management and data retrieval.

Some CDUs address the challenge of bridging compressed DRAM and an uncompressed SLC. For example, a multimedia intellectual property (MMIP) module writes compressed data to DRAM, which is later accessed by the CPU. Since the SLC stores uncompressed cache lines (CLs), the CPU attempts to read the requested CL directly from the SLC. On a cache hit, the data is returned immediately. However, on a cache miss, the SLC invokes the CDU to retrieve and decompress the relevant data from DRAM. The CDU performs the decompression at the data tile level, with each data tile consisting of multiple CLs. Once decompressed, the CDU inserts the entire tile into the SLC, making the requested CL available to the CPU. This approach provides compatibility between compressed main memory and uncompressed cache, allowing efficient on-demand decompression while reducing the need for pre-decompression or software intervention.

While the CDU in compressed memory systems performs on-demand decompression and caches the requested CL along with the rest of the data tile in the SLC, it caches and stashes the entire data tile containing the requested CL. This occurs even when the data may not be reused, leading to cache pollution and inefficient use of limited SLC space in cases of poor data locality. Furthermore, the CDU stashes the requested tile and does not attempt to stash other unrequested but potentially useful tiles, missing optimization opportunities in cases such as streaming applications where future data tiles could be predicted.

To address these types of issues, systems and methods are described herein for a CDU that introduces a caching and stashing engine (CSE) capable of making dynamic caching and stashing decisions based on real-time application behavior. Unlike CDUs that statically cache the requested data tile, this CDU offers flexibility by choosing whether or not to cache the requested CL and whether or not to stash additional, unrequested data tiles into the SLC. The CSE monitors performance monitoring units (PMUs) to assess the locality of the requested CL, e.g., using SLC hit rates, and references a tile stride histogram to detect streaming access patterns, allowing it to predict and stash future tiles. Based on these behavioral insights, the system can execute one of four caching/stashing actions: caching only, stashing only, both caching and stashing, or neither. This adaptive mechanism, which continually re-evaluates decisions at runtime, allows the CDU to reduce cache pollution, improve cache efficiency, and support a range of application access behaviors, which are features not available in prior CDU designs.

In an embodiment, a method of operating a compressed memory system includes: receiving a request for a CL; retrieving a first data tile from a memory in response to the request, the first data tile including the CL and a plurality of additional CLs; determining, based on application behavior, not to cache the CL in an SLC; determining, based on the application behavior, to stash a second data tile in the SLC; and stashing the second data tile in the SLC in response to the determination to stash.

In an embodiment, a compressed memory system includes: a memory configured to store compressed data tiles, each data tile including a plurality of CLs; an SLC configured to store decompressed CLs; a compression decompression unit configured to retrieve a first data tile from the memory in response to a request for a CL and decompress the first data tile, the first data tile including the CL and a plurality of additional CLs; and a CSE configured to: determine, based on application behavior, not to cache the CL in the SLC; determine, based on the application behavior, to stash a second data tile in the SLC; and cause the second data tile to be stashed in the SLC in response to the determination to stash.

In an embodiment, a non-transitory computer-readable medium storing instructions that, when executed by one or more processors, cause a compressed memory system to perform a method including: receiving a request for a CL; retrieving a first data tile from a memory in response to the request, the first data tile including the CL and a plurality of additional CLs; determining, based on application behavior, not to cache the CL in an SLC; determining, based on the application behavior, to stash a second data tile in the SLC; and stashing the second data tile in the SLC in response to the determination to stash.

### BRIEF DESCRIPTION OF THE DRAWING

In the following section, the aspects of the subject matter disclosed herein will be described with reference to exemplary embodiments illustrated in the figures, in which:

FIG. 1 is a diagram of a compressed memory system according to an embodiment;

FIG. 2 is a diagram of a CSE according to an embodiment;

FIG. 3 is a flowchart of a method of operating a compressed memory system according to an embodiment;

FIG. 4 is a flowchart of a method of determining caching based on application behavior according to an embodiment;

FIG. 5 is a flowchart of a method of determining stashing with streaming detection and tile prediction according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth. “Cache” as used herein refers to a memory structure used to temporarily store data for faster access relative to retrieving data from main memory. Some examples of “cache” are an SLC, a last-level cache, or any dedicated memory buffer that retains frequently or recently accessed data. “Stash” as used herein refers to storing a data tile in a cache, such as SLC. Some examples of “stash” operations are inserting a predicted next data tile into the SLC based on streaming access behavior. “Application behavior” as used herein refers to observable patterns or characteristics of how a software application accesses memory during execution. Some examples of “application behavior” are the frequency and reuse of specific CLs, the presence of sequential or streaming memory accesses, and the temporal or spatial locality of data tile access patterns. “Cache line or CL” as used herein refers to the smallest unit of data that can be transferred between memory and a cache in a single operation. Some examples of “cache line” are a 64-byte block of memory fetched from DRAM into the SLC, or a portion of a decompressed data tile containing multiple CLs. “Data tile” as used herein refers to a block of data comprising multiple CLs that is treated as a unit for compression, storage, or retrieval purposes. Some examples of “data tile” are a compressed memory block containing eight 64-byte CLs, or a decompressed segment of memory used to serve a CPU request.

According to an embodiment of the disclosure, a CDU is provided for use in compressed memory systems, incorporating a CSE that dynamically manages how data is cached or prefetched based on real-time application behavior. Unlike systems that statically cache all decompressed data tiles regardless of their reuse potential, this disclosure introduces intelligence to the decision-making process. Specifically, it allows the system to selectively cache the requested CL based on data locality, as determined by PMUs that track metrics such as cache hits, accesses, and reuse intervals. If the data is unlikely to be reused soon, caching can be skipped, thus reducing cache pollution and improving overall system efficiency.

In addition, the CDU supports proactive stashing of unrequested data tiles when a streaming access pattern is detected. The CSE monitors tile access history and maintains a tile stride histogram, which reflects directional consistency in tile access patterns. When the system identifies a consistent stride (e.g., mostly +1 or −1 strides), it interprets this as streaming behavior and predicts the next data tile likely to be accessed. That tile is then retrieved, decompressed, and stashed in the SLC ahead of time, ensuring low-latency access when the request arrives. These dynamic, adaptive decisions (based on real-time runtime behavior) represent an improvement over prior static CDU architectures, enabling better cache utilization, reduced latency, and smarter prefetching in modern SoCs.

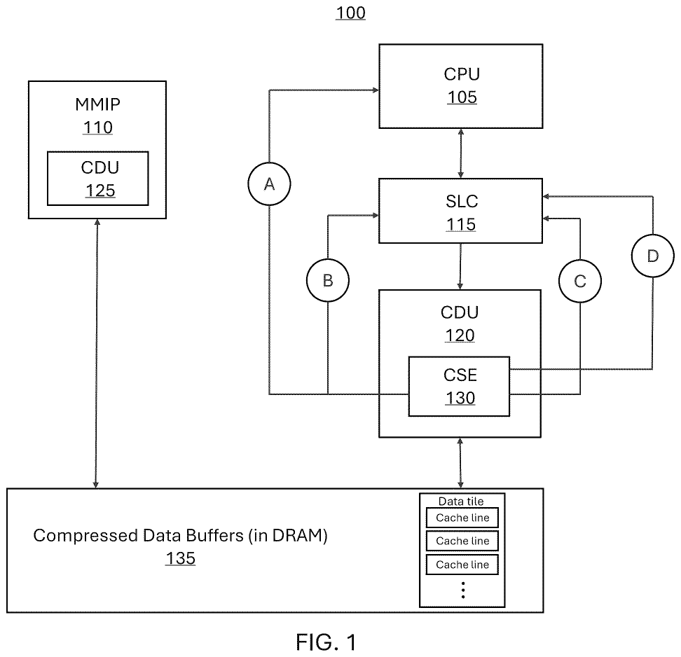

FIG. 1 illustrates a high-level block diagram of a compressed memory system 100 that incorporates a dynamic caching and stashing mechanism in accordance with embodiments of the present disclosure. The system 100 includes a CPU 105, an MMIP module 110, an SLC 115, and a CDU 120, which includes a CSE 130. The MMIP module 110 further includes its own CDU 125 and communicates with compressed data buffers 135 stored in a shared DRAM. The compressed data buffers 135 store data in compressed data tiles, each of which includes a plurality of CLs. A data tile may be retrieved and decompressed by the CDU 120 when a CL within the data tile is requested by the CPU 105.

While in the illustrated embodiment the compressed data buffers 135 reside in DRAM, this is not limiting. In other embodiments, the buffers may be located in other types of memory, such as high-bandwidth memory (HBM), embedded DRAM (eDRAM), non-volatile memory, or shared on-chip static RAM (SRAM), depending on system architecture and use case.

While the illustrated embodiment features the MMIP module 110 as a data producer, this is merely an example. In alternative implementations, the producer may be any other type of IP block capable of generating compressed data, such as a graphics processing unit (GPU), digital signal processor (DSP), neural network accelerator, or other specialized compute engines. The present disclosure is not limited to any specific type of producer IP.

In one embodiment, the CDU 120 may be implemented in hardware, such as a fixed-function logic block, an application-specific integrated circuit (ASIC), or a field-programmable gate array (FPGA). The hardware-based CDU 120 is configured to perform high-speed compression and decompression operations on data tiles as they are transferred between memory and the SLC 115.

The CSE 130, which operates within or alongside the CDU 120, may be implemented in software or firmware executed by an embedded processor or microcontroller integrated into the CDU 120. In some embodiments, the CSE 130 may be further implemented in hardware, such as control logic integrated into the CDU 120 or as part of an on-chip hardware state machine. The CSE 130 is responsible for making dynamic decisions about whether to cache requested CLs and whether to stash predicted data tiles based on application behavior. The CSE 130 interacts with the CDU 120 by directing when and how decompressed data should be placed into the SLC 115, depending on the outcome of the caching and stashing determinations. This division allows the CDU 120 to handle data movement and decompression efficiently in hardware, while the CSE 130 provides intelligent, adaptive control through programmable logic, for example.

The CPU 105 operates as a consumer of compressed data, executing application-level software that issues requests for CLs. The producer IP (e.g., MMIP module 110) compresses multimedia or other data and stores it in data tile format in the compressed data buffers 135. Its associated CDU 125 performs the compression function. On the consumer side, the CDU 120 retrieves and decompresses data from the memory system and, with the help of the CSE 130, determines whether to cache the requested data and whether to stash additional, unrequested data tiles in the SLC 115. The CSE 130 evaluates these decisions dynamically based on application access behavior and real-time performance monitoring.

The general flow of data through the system 100 is illustrated by processes A through D. Prior to the illustrated flow, a producer IP, such as the MMIP module 110, generates raw multimedia data, compresses the data using its dedicated CDU 125, and stores the resulting compressed data tiles in the compressed data buffers 135 located in system memory (e.g., DRAM). The compressed data remains in tile granularity and is available for subsequent access by the CPU 105 or other consumer IPs. In the illustrated flow, process A depicts a scenario in which the CDU 120, in response to a CPU 105 request for a CL, retrieves and decompresses a corresponding data tile from the compressed data buffers 135, but based on analysis performed by the CSE 130, does not cache the requested CL in the SLC 115. This may occur when the CSE 130 determines that the CL exhibits poor data locality or is unlikely to be reused soon. In process A, the requested CL is delivered directly to the CPU 105.

Process B depicts a case in which the CSE 130 determines that the requested CL should be retained, and accordingly the CDU 120 stores the CL in the SLC 115 after decompression. In process C, only the requested data tile is stashed in the SLC 115. Process D illustrates an example of proactive stashing, where the CSE 130 detects a streaming access pattern based on access history and stride analysis. In this case, for example, the CDU 120 decompresses a second, predicted data tile that has not yet been requested and stashes it into the SLC 115 to improve future access latency.

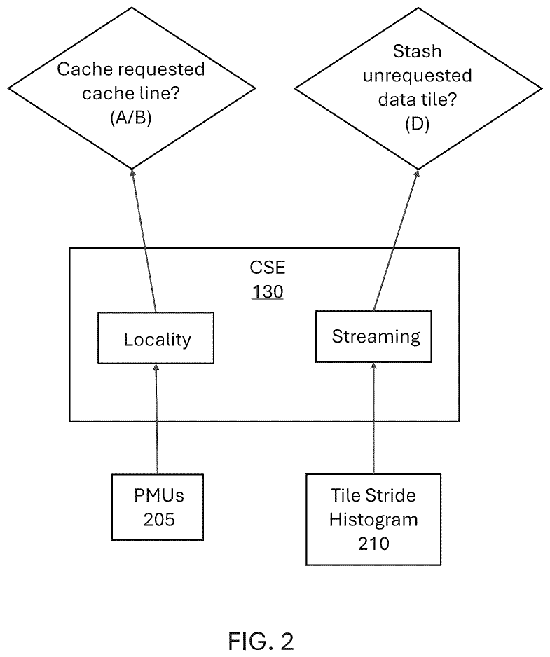

FIG. 2 illustrates a block diagram of the CSE 130, which is incorporated within the CDU 120 of system 100. The CSE 130 is configured to dynamically manage how decompressed data is handled by the SLC 115 in response to requests from the CPU 105. Specifically, the CSE 130 performs two primary functions based on runtime application behavior: (1) determining whether to cache the requested CL, and (2) determining whether to stash a second, unrequested data tile that may be needed in the future.

To support the caching decision, the CSE 130 monitors performance metrics collected by one or more PMUs 205 associated with the SLC 115. These metrics may include the number of cache hits, cache accesses, and reuse intervals for recently accessed CLs. By evaluating these metrics, the CSE 130 is able to estimate the data locality of the requested CL and determine whether caching it would be beneficial. Separately, to support the stashing decision, the CSE 130 maintains or has access to a tile stride histogram 210 that records stride values, e.g., address differences, between consecutively accessed data tiles. By analyzing the tile stride histogram 210, the CSE 130 can determine whether the application exhibits a streaming access pattern, in which case the CSE 130 may predict the next data tile to be accessed and trigger preloading (e.g., stashing) of that tile into the SLC 115. This adaptive decision-making allows the system to reduce cache pollution and improve memory access efficiency in both spatially and temporally varying workloads.

To assess the locality of a requested CL, the CSE 130 monitors performance metrics gathered from the PMUs 205 associated with the SLC 115. A PMU may be implemented as a set of hardware counters, trace buffers, or programmable event-tracking logic integrated into the CSE 130 or memory management hardware. The PMUs 205 provide low-level runtime statistics reflecting memory access behavior, allowing the CSE 130 to make informed caching decisions based on actual application usage patterns. In particular, the CSE 130 uses the PMU data to estimate how frequently and recently the requested CL (or CLs from the same data tile) have been accessed. This estimation serves as a proxy for data locality, which indicates the likelihood that the CL will be reused soon.

Examples of performance metrics gathered by the PMUs 205 include the number of cache accesses, the number of cache hits, and the reuse interval for specific addresses or regions. For instance, the CSE 130 may calculate an SLC hit rate for the requested CL or its corresponding data tile by dividing the number of hits by the total number of accesses over a sampling window. If this hit rate exceeds a predefined threshold, the CSE 130 determines that the data exhibits high locality and caches the requested CL in the SLC 115. If the hit rate is below the threshold, caching may be bypassed to prevent pollution of the cache with data that is unlikely to be reused. The threshold may be fixed or dynamically adjusted based on system load or access patterns. This runtime analysis provides adaptive, context-aware caching, reducing unnecessary memory traffic and improving cache utilization.

To determine whether an application exhibits streaming or non-streaming data access behavior, the CSE 130 analyzes the tile stride histogram 210 that reflects the access pattern of data tiles over time. Each time a new data tile is accessed, the CSE 130 computes a tile stride value, e.g., the difference between the current tile number and the previously accessed tile number. The stride may be positive, negative, or zero, and represents the directional change in memory access. The computed stride is recorded in the tile stride histogram 210, which accumulates a distribution of stride values based on recently observed tile accesses. The tile stride histogram 210 may serve as a statistical model of access behavior across a moving time window.

Streaming access behavior is inferred when the tile stride histogram 210 shows a dominant pattern in a single direction, for example, if the majority of recorded strides are positive, indicating forward sequential access. Similarly, predominantly negative strides may indicate reverse streaming. In some cases, a small proportion of opposite-direction strides may be tolerated without invalidating the streaming classification, such as allowing a limited number of negative strides in a mostly positive histogram. If no dominant stride direction is observed, e.g., the stride distribution appears random or evenly mixed, the CSE 130 classifies the behavior as non-streaming, and stashing is not triggered.

When streaming access is detected, the CSE 130 utilizes the tile stride histogram 210 to predict the next data tile likely to be accessed by the CPU 105. The prediction may be based on several heuristics, including selecting the most frequently occurring stride, the most recently observed stride, or an average of recent stride values. The predicted stride is then applied to the current tile index to generate a target tile number. The corresponding data tile is retrieved from memory, decompressed, and stashed into the SLC 115. This allows for low-latency access to the tile upon future request, improving performance in applications with streaming behavior such as multimedia processing, sequential file parsing, or artificial intelligence (AI) workloads. The stashing decision can be continuously re-evaluated as new tile access patterns emerge, ensuring that system resources are allocated adaptively and efficiently.

A case in which the CL is not cached and the unrequested data tile is not stashed may occur when the application exhibits random access patterns to many different CLs across a wide range of data tiles. A case in which the CL is not cached and the unrequested data tile is stashed may occur when the application iterates through a large image that cannot fit into the SLC 115. A case in which the CL is cached and the unrequested data tile is not stashed may occur during typical CPU access patterns that exhibit high intra-tile locality but lack consistent or predictable inter-tile slides. A case in which the CL is cached and the unrequested data tile is stashed may occur when the application iterates through a small image (that can fit into the SLC 115) multiple times.

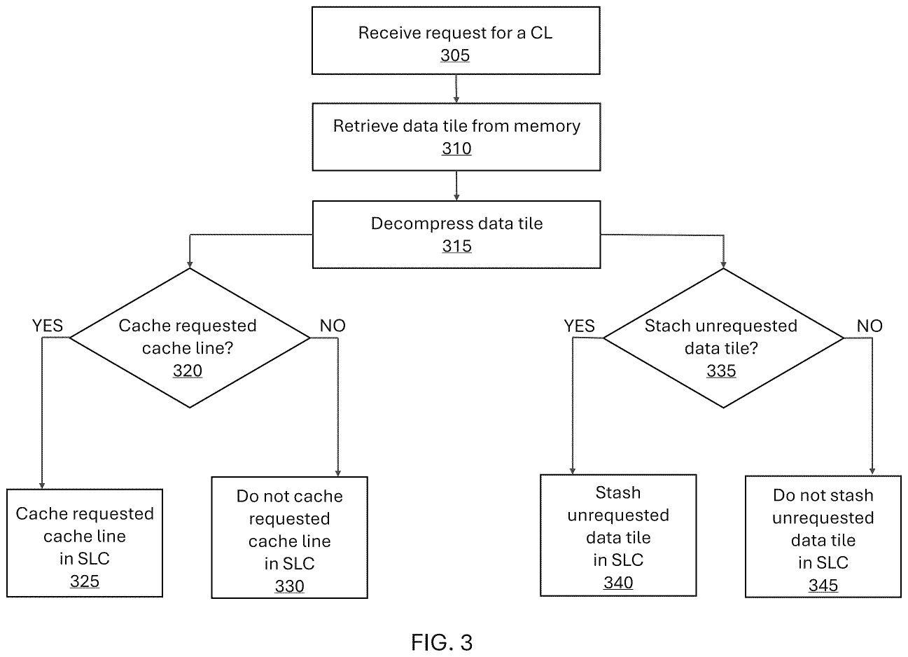

FIG. 3 illustrates a method for operating the compressed memory system 100 using dynamic caching and stashing decisions based on application behavior. At 305, a request for a CL is received from a processor such as the CPU 105. For example, the CPU 105 may request a CL located at memory address 0xA004. In 310, the system 100 retrieves a corresponding data tile from the memory 135. The retrieved tile includes the requested CL along with additional CLs, such as a tile containing eight total CLs spanning addresses 0xA000 through 0xA01C.

At 315, the data tile is decompressed to reconstruct the original CL values. For example, the tile is decompressed using a suitable algorithm (e.g., delta encoding, dictionary compression) to recover all eight CLs in uncompressed form. In 320, the system 100 performs a first determination to assess whether the requested CL should be cached in the SLC 115. This determination is based on runtime application behavior, such as locality statistics gathered from the PMUs 205. If the system 100 determines that the requested CL has exhibited a high hit rate, e.g., 85% in recent sampling windows, it may decide to cache the requested CL. In some implementations, this caching determination may occur concurrently with or independently of the stashing determination described below.

If the decision is affirmative, the requested CL is cached in the SLC 115 (325), for example, by storing CL 0xA004. If the data locality is insufficient (e.g., the hit rate is below a predefined threshold), the CL is not cached (330) to avoid unnecessary cache pollution. The method then proceeds to 335, where the system 100 performs a second determination to evaluate whether a second, unrequested data tile should be stashed in the SLC 115. This decision is based on an analysis of the application's access pattern. For instance, if the CSE 130 determines, using the tile stride histogram 210, that the application has been accessing sequential tiles with a stride of +1, it may classify the access pattern as streaming.

If a streaming pattern is detected, a next tile is predicted, retrieved, decompressed, and proactively stashed in the SLC (340). For example, if the current tile index is 0xA000 and the stride is +1, the system may prefetch tile 0xA100 and stash it for future access. If no consistent stride is detected, the second data tile is not stashed (345), and the method concludes at 350. This approach provides efficient and adaptive memory usage, improving performance in streaming and bursty workloads while minimizing unnecessary caching. This stashing determination may also be performed independently from the caching determination and at a different time, such as during background monitoring or in response to ongoing access history.

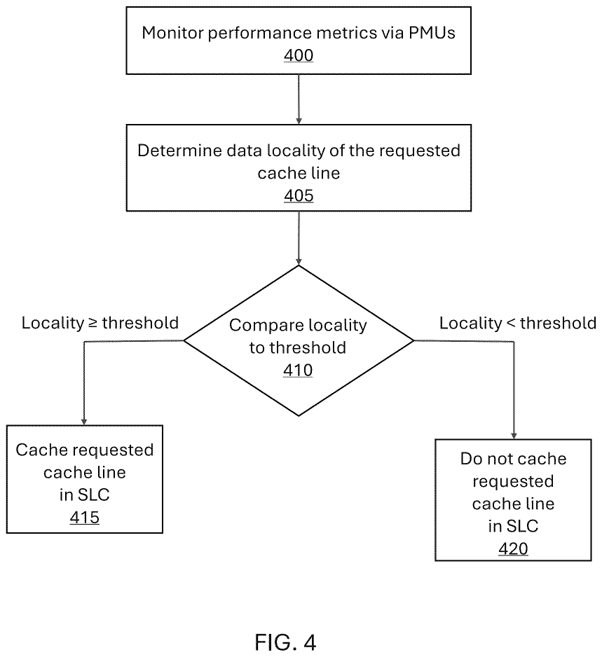

FIG. 4 illustrates a sub-process for making caching decisions in the compressed memory system 100 based on application behavior, as monitored by performance metrics. The process begins at 400, where the PMUs 205 are used to collect runtime statistics associated with the SLC 115. These metrics may include, for example, the number of accesses and cache hits associated with the requested CL. In one example, the system 100 observes 64 accesses and 52 hits to a specific CL at address 0xA004.

At 405, the system 100 determines the data locality of the requested CL by analyzing the PMU output. In the example above, the hit rate is calculated to be approximately 81.25%. The method then proceeds to 410, where the calculated data locality is compared against a predefined or dynamically-adjusted caching threshold. For example, if the threshold is 75%, the observed locality exceeds the requirement.

If the locality is determined to meet or exceed the threshold, the method proceeds to 415, where the requested CL is cached in the SLC 115, for example, CL 0xA004 is stored to ensure faster access upon reuse. If, however, the locality is found to fall below the threshold, the system 100 executes 420, where the requested CL is not cached, thus avoiding unnecessary cache pollution for low-reuse data.

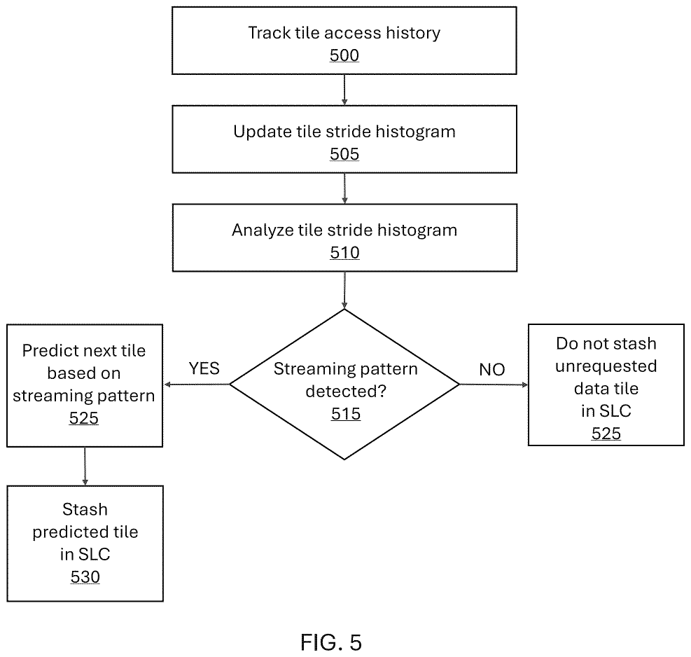

FIG. 5 illustrates a method 500 for dynamically determining whether to stash a second data tile in the SLC 115 based on application access behavior. This stashing logic is triggered when the CSE 130 determines that the application may be exhibiting a streaming data access pattern. The method begins at 500, where the system 100 tracks the history of data tile accesses. For example, the system 100 may observe sequential accesses to tile indices 100, 101, and 102.

At 505, the system 100 updates the tile stride histogram 210, which records the stride values, e.g., the differences in tile indices between consecutive accesses. In this example, the histogram reflects repeated stride values of +1. At 510, the histogram 210 is analyzed to determine whether the observed strides exhibit directional consistency. If a majority of the recorded strides have the same sign (e.g., positive), the system 100 considers this evidence of streaming access behavior.

At 515, the CSE 130 determines whether a streaming pattern has been detected. If the result is negative, the system 100 proceeds to 525, where it elects not to stash any unrequested data tile. However, if streaming behavior is detected, the method continues to 520, where the system 100 predicts the next tile to be accessed using the most frequent stride value or the most recently observed stride. For example, with a stride of +1 and current tile index 102, the system 100 predicts tile 103. At 530, the predicted tile is retrieved, decompressed, and stashed into the SLC 115 so that it is readily available when requested.

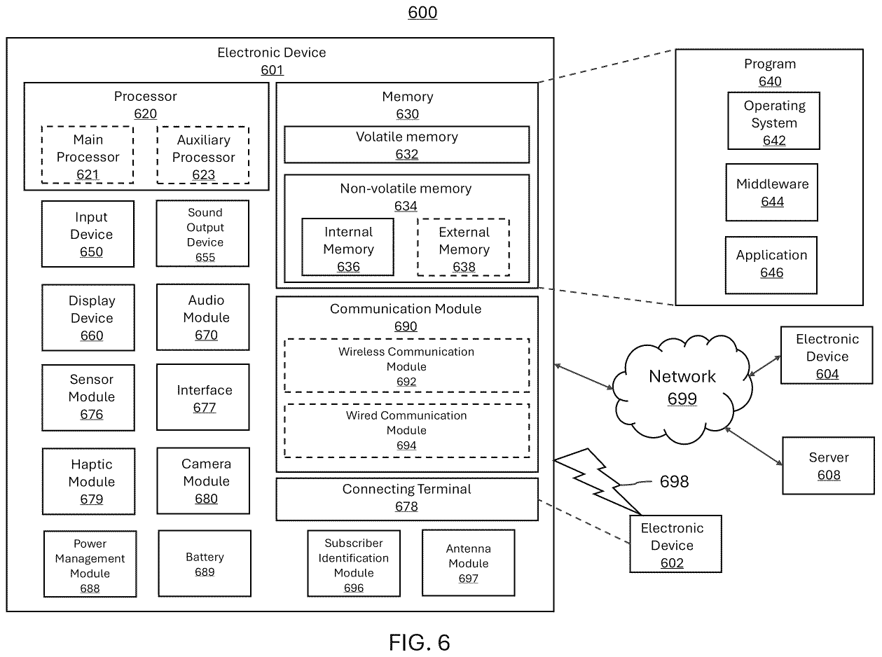

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a CPU or an application processor (AP)), and an auxiliary processor 623 (e.g., a GPU, an ISP, a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an ISP or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, ISPs, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

In an embodiment, the method disclosed herein may be performed by the electronic device 601 shown in FIG. 6. The method may be executed by a main processor (e.g., processor 621) and may utilize program instructions (e.g., program 640) stored in memory (e.g., memory 630). The CDU 120 may be implemented as dedicated hardware logic located within the processor 621 or as a separate on-chip hardware block coupled to the memory's interface. The CSE 130 may also be implemented in hardware, such as control logic integrated within the CDU 120, or alternatively in software or firmware executed by the processor 621.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of operating a compressed memory system comprising:
receiving a request for a cache line (CL);
retrieving a first data tile from a memory in response to the request, the first data tile including the CL and a plurality of additional CLs;
determining, based on application behavior, not to cache the CL in a system level cache (SLC);
determining, based on the application behavior, to stash a second data tile in the SLC; and
stashing the second data tile in the SLC in response to the determination to stash.

2. The method of claim 1, wherein determining not to cache the CL in the SLC comprises:
monitoring performance metrics using one or more performance monitoring units; and
determining a data locality of the CL based on the performance metrics,
wherein the CL is not cached in the SLC in response to the data locality satisfying a threshold.

3. The method of claim 2, wherein the performance metrics comprise at least one of:
a number of SLC accesses,
a number of SLC hits, or
a reuse interval of the CL.

4. The method of claim 1, wherein determining to stash the second data tile in the SLC comprises:
tracking a tile stride histogram based on tile access history; and
detecting a streaming access pattern using the tile stride histogram, wherein stashing the second data tile in the SLC is performed in response to detecting the streaming access pattern.

5. The method of claim 4, wherein the tile stride histogram comprises a record of stride values indicating address differences between consecutively accessed data tiles.

6. The method of claim 5, wherein detecting the streaming access pattern comprises determining that a majority of the stride values in the tile stride histogram have the same sign.

7. The method of claim 4, further comprising predicting a next tile to be accessed based on the tile stride histogram, wherein the next tile is the second data tile.

8. A compressed memory system, comprising:
a memory configured to store compressed data tiles, each data tile including a plurality of cache lines (CLs);
a system level cache (SLC) configured to store decompressed CLs;
a compression decompression unit configured to retrieve a first data tile from the memory in response to a request for a CL and decompress the first data tile, the first data tile including the CL and a plurality of additional CLs; and
a caching and stashing engine (CSE) configured to:
determine, based on application behavior, not to cache the CL in the SLC;
determine, based on the application behavior, to stash a second data tile in the SLC; and
cause the second data tile to be stashed in the SLC in response to the determination to stash.

9. The system of claim 8, wherein the CSE is further configured to:
monitor performance metrics using one or more performance monitoring units; and
determine data locality of the CL based on the performance metrics,
wherein the CL is not cached in the SLC in response to the data locality satisfying a threshold.

10. The system of claim 9, wherein the performance metrics comprise at least one of:
a number of SLC accesses,
a number of SLC hits, or
a reuse interval of the CL.

11. The system of claim 8, wherein the CSE is further configured to:
track a tile stride histogram based on tile access history; and
detect a streaming access pattern using the tile stride histogram, wherein stashing the second data tile in the SLC is performed in response to detecting the streaming access pattern.

12. The system of claim 11, wherein the tile stride histogram comprises a record of stride values indicating address differences between consecutively accessed data tiles.

13. The system of claim 12, wherein detecting the streaming access pattern comprises determining that a majority of the stride values in the tile stride histogram have the same sign.

14. The system of claim 11, wherein the CSE is further configured to:
predict a next tile to be accessed based on the tile stride histogram, wherein the next tile is the second data tile.

15. A non-transitory computer-readable medium storing instructions that, when executed by one or more processors, cause a compressed memory system to perform a method comprising:
receiving a request for a cache line (CL);
retrieving a first data tile from a memory in response to the request, the first data tile including the CL and a plurality of additional CLs;
determining, based on application behavior, not to cache the CL in a system level cache (SLC);
determining, based on the application behavior, to stash a second data tile in the SLC; and
stashing the second data tile in the SLC in response to the determination to stash.

16. The non-transitory computer-readable medium of claim 15, wherein determining not to cache the CL in the SLC comprises:
monitoring performance metrics using one or more performance monitoring units; and
determining a data locality of the CL based on the performance metrics,
wherein the CL is not cached in the SLC in response to the data locality satisfying a threshold.

17. The non-transitory computer-readable medium of claim 16, wherein the performance metrics comprise at least one of:
a number of SLC accesses,
a number of SLC hits, or
a reuse interval of the CL.

18. The non-transitory computer-readable medium of claim 15, wherein determining to stash the second data tile in the SLC comprises:
tracking a tile stride histogram based on tile access history; and
detecting a streaming access pattern using the tile stride histogram, wherein stashing the second data tile in the SLC is performed in response to detecting the streaming access pattern.

19. The non-transitory computer-readable medium of claim 18, wherein the tile stride histogram comprises a record of stride values indicating address differences between consecutively accessed data tiles.

20. The non-transitory computer-readable medium of claim 18, further comprising:
predicting a next tile to be accessed based on the tile stride histogram, wherein the next tile is the second data tile.
